(19) United States
(12) Patent Application Publication
(10) Pub. No.: US 2002/0120772 A1
(43) Pub. Date: Aug. 29, 2002

(54) Manager-to-agent model system

(76) Inventors: Toshiyuki Yada, Kawasaki (JP); Kiyofumi Hara, Kawasaki (JP)

Correspondence Address: Rosenman & Colin LLP, 575 Madison Avenue, New York, NY, 10022-2585, US

(21) Appl. No.: 10/113,635

(22) Filed: Mar. 27, 2002

Related U.S. Application Data
(63) Continuation of application No. PCT/JP99/05411, filed on Oct. 1, 1999.

(51) Int. Cl. G06F 15/173; G06F 15/16

(52) U.S. Cl. 709/238; 709/202

(57) ABSTRACT

An autonomous message transmission method in a manager-to-agent model system including a manager and an agent respectively accommodated in an IP network, comprises transmitting a command/response oriented command based on a connection-oriented protocol to the manager from the agent before transmitting a first autonomous message including a time when starting up a system, and transmitting an autonomous message based on a connectionless protocol when confirming some response to the agent from the manager.

This is a continuation of Application PCT/JP 99/05411, filed on Oct. 1,1999, now abandoned.

### BACKGROUND OF THE INVENTION

The present invention relates generally to a manager-to-agent model system having a manager-to-agent architecture based on SNMP (Simple Network Management Protocol), and more particularly to a method and a system for assuring a UDP (User Datagram Protocol)—based transmission of an autonomous notification (message) in this manager-to-agent model system.

In the manager-to-agent model system having the manager-to-agent architecture, SNMP is defined as a protocol for transferring management information between a management target system and a management station for managing a network that operates on UDP. Generally, according to SNMP, an agent residing in the management target system notifies a manager of management information in response to a processing request given from the manager residing in the management station.

A request and a response are transferred as SNMP messages between the manager and the agent. TRAP (trouble-related notification) among messages (GET, GET-NEXT, SET and TRAP) based on SNMP may be defined as a message transmitted based on UDP autonomously (uni-directionally) from the agent, and is used for notifying the manager of a trouble in the network and a state of an agent-resided system.

The transmission of TRAP as the autonomous message is based on UDP defined as a connectionless protocol, and therefore a communication path between the agent and the manager is not (any session is not established) Further, there is no response from the manager (UDP does not return ACK), and hence there is no assurance (confirmation) that the message surely arrives at the manager. Moreover, the agent transmits TRAP as the autonomous message to the manager only once and does not check whether TRAP surely arrives at the manager.

Thus, there is no assurance of surely delivering the message to the manager simply by transmitting TRAP as the autonomous message based on SNMP that operates on UDP, it might happen that TRAP is lost due to a state (congestion, trouble and so on) of the network and is not received due to a state (power-off and others) of the manager. Consequently, it might also happen that the critical trouble cannot be troubleshot, or troubleshooting is delayed.

Further, it can be considered that there is used TCP (Transmission Control Protocol) defined as a connection-oriented protocol requiring the communication path to be established between a source and a destination, however, there is a possibility in which the TCP is unable to be compatible with the standard rules of SNMP as the protocol for TRAP changes.

### SUMAMRY OF THE INVENTION

It is a primary object of the present invention, which was devised to obviate the problems described above, to provide a manager-to-agent model system, particularly an agent-resided system and an autonomous message transmission method, which are capable of surely delivering an autonomous message (notification) from an agent to a manager on the basis of a connectionless protocol by utilizing a standard-implemented function.

To accomplish the above object, in a manager-to-agent model system including a manager and an agent respectively accommodated in an IP network, a first autonomous message transmission method according to the present invention comprises transmitting a command/response oriented command based on a connection-oriented protocol to the manager from the agent before transmitting a first autonomous message including a time when starting up a system, and transmitting an autonomous message based on a connectionless protocol when confirming some response to the agent from the manager.

In a manager-to-agent model system including a manager and an agent respectively accommodated in an IP network, a second autonomous message transmission method according to the present invention comprises managing communications with the manager when normally operated after starting up a system, transmitting a command/response oriented command based on a connection-oriented protocol before the agent transmits an autonomous message based on a connectionless protocol to the manage if a predetermined time elapses since a message was finally received from the manager or transmitted to the manager, and transmitting the autonomous message when confirming some response to the agent from the manager.

In a manager-to-agent model system including a manager and an agent respectively accommodated in an IP network, a third autonomous message transmission method according to the present invention comprises monitoring a signal receiving interval in periodic monitoring in the agent when the manager periodically monitors the agent, transmitting a command/response oriented command based on a connection-oriented protocol before transmitting an autonomous message based on a connectionless protocol when judging that the signal for the periodic monitoring is not received, and transmitting the autonomous message when confirming some response to the agent from the manager.

In a manager-to-agent model system including a manager and an agent respectively accommodated in an IP network, a fourth autonomous message transmission method comprises transmitting an autonomous message based on a connectionless protocol to the manager from the agent, and judging whether to transmit a command/response oriented command based on a connection-oriented protocol in accordance with a weight of the predefined autonomous massage before transmitting the autonomous message based on the connectionless protocol.

In a fifth autonomous message transmission method according to the present invention, in the first, second or third autonomous message transmission method, the transmission of the command/response oriented command is retried till the response from the manager to the agent is confirmed, and the autonomous message is transmitted when confirming the response.

In a sixth autonomous message transmission method according to the present invention, in the fifth autonomous message transmission method, retry count information mapped to the weight of the autonomous message is retained, and a retry count of the transmission of the command/response oriented command is set changeable based on the weight of the autonomous message.

In a seventh autonomous message transmission method according to the present invention, in the fifth autonomous message transmission method, retry interval information mapped to the weight of the autonomous message is retained, and a retry interval of the transmission of the command/response oriented command is set changeable based on the weight of the autonomous message.

In each of the autonomous message transmission methods of the present invention, the connectionless protocol is SNMP that supports UDP, and the autonomous message is TRAP based on SNMP. Further, the connection-oriented protocol is Telnet that supports TCP.

A first agent-resided system according to the present invention comprises a module transmitting a command/response oriented command based on a connection-oriented protocol to a manager via an IP network before transmitting a first autonomous message including a time when starting up the system, and a module transmitting an autonomous message based on a connectionless protocol when confirming some response from the manager.

A second agent-resided system according to the present invention comprises a module managing communications with a manager via an IP network when normally operated after starting up the system, a module transmitting a command/response oriented command based on a connection-oriented protocol before transmitting an autonomous message based on a connectionless protocol to the manage if a predetermined time elapses since a message was finally received from the manager or transmitted to the manager, and a module transmitting the autonomous message when confirming some response from the manager.

A third agent-resided system according to the present invention comprises a module monitoring a signal receiving interval in periodic monitoring in the agent when a manager executes periodic monitoring via an IP network, a module transmitting a command/response oriented command based on a connection-oriented protocol before transmitting an autonomous message based on a connectionless protocol when judging that the signal for the periodic monitoring is not received, and a module transmitting the autonomous message when confirming some response from the manager.

A fourth agent-resided system according to the present invention comprises a module transmitting an autonomous message based on a connectionless protocol to a manager via an IP network, and a module judging whether to transmit a command/response oriented command based on a connection-oriented protocol in accordance with a weight of the predefined autonomous massage before transmitting the autonomous message based on the connectionless protocol.

A fifth agent-resided system according to the present invention, in the first, second or third agent-resided system, the transmission of the command/response oriented command is retried till the response from the manager to the agent is confirmed, and the autonomous message is transmitted when confirming the response.

A sixth agent-resided system according to the present invention, in the fifth agent-resided system, further comprises a module retaining retry count information mapped to the weight of the autonomous message, and setting changeable a retry count of the transmission of the command/response oriented command on the basis of the weight of the autonomous message.

A seventh agent-resided system according to the present invention, in the fifth agent-resided system, further comprises a module retaining retry interval information mapped to the weight of the autonomous message, and setting changeable a retry interval of the transmission of the command/response oriented command on the basis of the weight of the autonomous message.

In each agent-resided system according to the present invention, the connectionless protocol is SNMP that supports UDP, and the autonomous message is TRAP based on SNMP. Further, the connection-oriented protocol is Telnet that supports TCP.

In each of the methods and the systems of the present invention, the autonomous message (TRAP based on SNMP) can be surely delivered from the agent to the manager on the basis of the connectionless protocol (UDP), whereby a miss and a delay in troubleshooting a critical trouble or detecting an important event due to a loss of the autonomous message can be minimized.

Further, the present invention involves the use of the standard-implemented command (protocol) as the command/response oriented (connection-oriented protocol: TCP) command and can be applied to the multi-vendor environment.

In the first method and the first system of the present invention, even if individual states are unknown as in the case of initial boots of the manager, the agent and the network, the states of the manager and of the network can be simultaneously confirmed beforehand by transmitting the command/response oriented command, and hence the autonomous message (TRAP) can be surely delivered to the manager.

In the second method and the second system of the present invention, even if the communications with the manager are interrupted for a fixed period of time and the state of the manager is unknown, the states of the manager and of the network can be simultaneously confirmed beforehand by transmitting the command/response oriented command, and hence the autonomous message (TRAP) can be surely delivered to the manager.

In the third method and the third system of the present invention, a state of steady monitoring from the manager is monitored, and, even if the state of the manager is unknown due to an interruption of the steady monitoring such as periodic polling (a monitoring technique), the states of the manager and of the network can be simultaneously confirmed beforehand by transmitting the command/response oriented command. Hence, the autonomous message (TRAP) can be surely delivered to the manager.

In the fourth method and the fourth system of the present invention, an issuance of the command/response oriented command is controlled based on a weighted autonomous message (TRAP), and therefore the autonomous message (TRAP) can be surely delivered to the manager in a way that restrains both of the unnecessary communications and a load on the network.

In the fifth method and the fifth system of the present invention, since the issuance of the command/response oriented command is retried, if the manager or the network is recovered from a trouble etc, the autonomous message (TRAP) is delivered to the manager simultaneously with the restoration, whereby a delay of detecting a change in state such as an alarm etc can be minimized.

In the sixth and seventh methods and systems of the present invention, the retry process is controlled based on the weighted autonomous message (TRAP), hereby the load on the network can be restrained.

### BRIEF DESCRIPTION OF THE DRAWINGS

These objects and advantages of the present invention will become more apparent and more readily appreciated from the following detailed description of the presently preferred exemplary embodiments, taken in conjunction with the accompanying drawings of which:

FIG. 1 is a block diagram showing a manager-to-agent model system in on embodiment of the present invention;

FIG. 2 is an explanatory diagram showing an architecture and an operation of an agent-resided system shown in FIG. 1;

FIG. 3 is a diagram showing an example of a command/response oriented command issuance request datagram format;

FIG. 4 is an explanatory block diagram showing an operational example 1 of the agent-resided system;

FIG. 5 is a diagram showing an example of a TRAP hysteresis flag;

FIG. 6 is a flowchart showing processes in the agent-resided system shown in FIG. 4;

FIG. 7 is an explanatory block diagram showing an operational example 2 of the agent-resided system;

FIG. 8 is a diagram showing an example of a TRAP inhibition flag;

FIG. 9 is a flowchart showing processes of a transmission/receipt management module in the agent-resided system shown in FIG. 7;

FIG. 10 is a flowchart showing processes of a TRAP management module, the transmission/receipt management module and a TCP transmission/receipt management module in the agent-resided system shown in FIG. 7;

FIG. 11 is an explanatory block diagram showing an operational example 3 of the agent-resided system;

FIG. 12 is a diagram showing an example of a steady monitoring information flag;

FIG. 13 is a flowchart showing processes of a steady monitoring management module in the agent-resided system shown in FIG. 11;

FIG. 14 is a flowchart showing processes of the TRAP management module, the steady monitoring management module and the TCP transmission/receipt management module in the agent-resided system shown in FIG. 11;

FIG. 15 is an explanatory block diagram showing an operational example 4 of the agent-resided system;

FIG. 16 is a diagram showing an example of a TRAP weighting information table;

FIG. 17 is a flowchart showing processes in the agent-resided system shown in FIG. 15;

FIG. 18 is an explanatory block diagram showing an operational example 5 of the agent-resided system;

FIG. 19 is an explanatory block diagram showing an operational example 6 of the agent-resided system;

FIG. 20 is a diagram showing an example of the TRAP weighting information table; and

FIG. 21 is a flowchart showing processes in the agent-resided system shown in FIG. 19.

### DETAILED DESCRIPTION OF THE PREFERRED EMBODIMENTS

Embodiments of the present invention will hereinafter be described with reference to the accompanying drawings.

### Architecture of Manager-to-Agent Model System

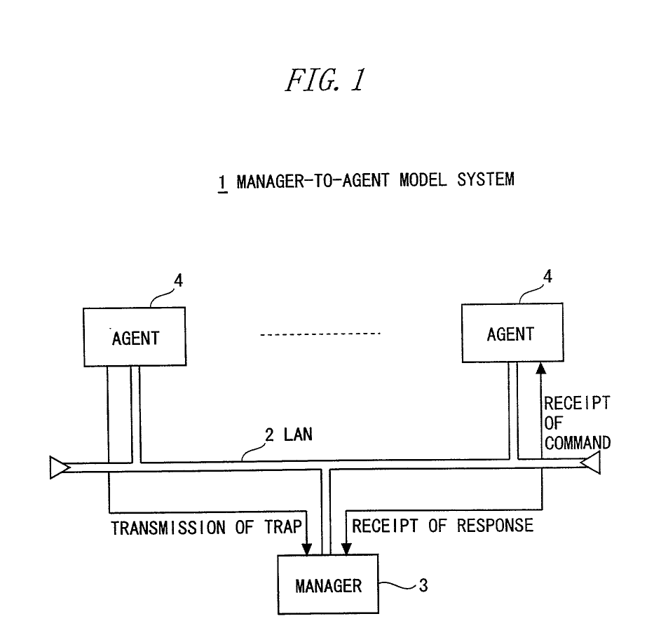

FIG. 1 shows one embodiment of the present invention. Referring to FIG. 1, a manager-to-agent model system 1 has a manager-to-agent architecture based on SNMP (Simple Network Management Protocol). The manager-to-agent model system 1 includes a manager 3 and a plurality of agents 4 which are respectively accommodated in a LAN (Local Area Network) such as Ethernet serving as an IP (Internet Protocol) network, and configures a network management (monitor) system.

The manager 3 on a management station monitors the LAN 2 and the plurality of agents 4 on a management target system. As will be exemplified, the agent 4 on the management target system 4 notifies the manager 3 of a piece of management information (response) in response to a processing request (command) given from the manager 3 on the management station according to TCP (Transmission Control Protocol) as a connection-oriented protocol.

Further, the notification between the manager 3 and the agent 4 involves the use of TRAP (trouble-related notification) among messages (GET, GET-NEXT, SET and TRAP) based on SNMP defined as a protocol for transferring the management information between a management target system (agent) and a management station (manager) for managing the network that operate on UDP (User Datagram Protocol) in order to notify of a trouble in the network and a state of a system in which the agent 4 resides. TRAP is autonomously (uni-directionally) transmitted to the manager 3 from the agent 4.

When sending TRAP as an autonomous message, the protocol is UDP defined as a connectionless protocol, and hence a communication path between the agent and the manager is not ensured (a session is not established and so on). Further, since there is no response from the manager, there is no assurance that the message is not surely delivered to the manager. This problem can be, however, obviated by confirming that any response is given beforehand from the manager 3 on the basis of TCP.

According to the system described above, the manager 3 is disposed on the LAN 2 accommodating the agents 4 but may take such a form as to be accommodated in other IP network connected to the LAN 2. Further, the agent 4 resides in a PC (Personal computer), a router, a server or a switch.

### Outline of Architecture and Operation of Agent-Resided System

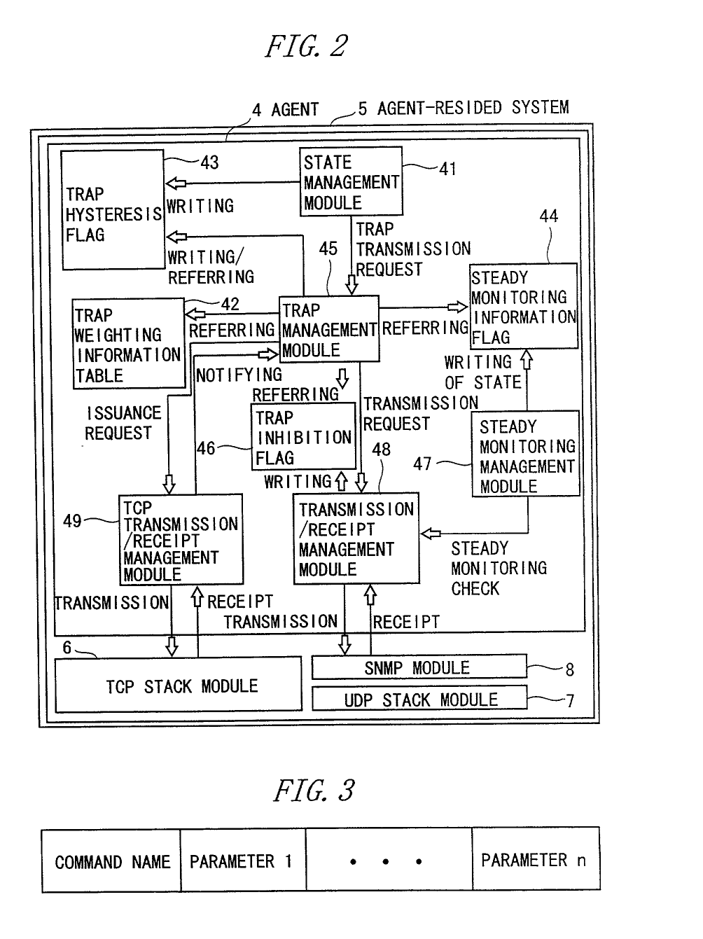

Next, an architecture and an operation of a system in which the agent 4 shown in FIG. 1 resides, will be explained referring to FIG. 2. FIG. 3 shows an example of a command/response oriented command issuance request datagram format.

A system 5 with the agent 4 residing therein includes, in addition to the agent 4, a TCP stack (protocols) module 6, a UDP stack (protocols) module 7, and an SNMP (protocol) module 8. The agent 4 has a state management module 41 for managing a state o the system 5, a TRAP hysteresis flag 43 having a piece of information indicating whether it is the first TRAP (autonomous message) after being booted, and a TRAP management module 45 for managing TRAP sent from the state management module 41.

When booted such as power-on etc, the state management module 41 requests the TRAP management module 45 to send TRAP indicating the boot etc. The TRAP management module 45 refers to the TRAP hysteresis flag 43 and thus judges whether it is the first TRAP. If it is the first TRAP, the TRAP management module 45 requests the TCP stack 6 to issue a command/response oriented command (see FIG. 3).

The agent 4 further includes a transmission/receipt management module 48 for managing a transmission and a receipt of the message to and from the manager 3, and a TRAP inhibition flag 46 representing a piece of information for judging states of the manager 3 and of the network 2.

The transmission/receipt management module 48 monitors a message transmission/receipt state to and from the manager 3 that normally operates and, if nothing transmitted and received within a given period of time, sets ON the TRAP inhibition flag 46. The TRAP management module 45, when a TRAP transmission occurs, refers to the TRAP inhibition flag 46. If set ON, the TRAP management module 45 requests the TCP stack module 6 to issue the command/response oriented command.

The agent 4 further includes a steady monitoring management module 47 for monitoring whether it is steadily monitored by the manager 3, and a steady monitoring information flag 44 for indicating whether the steady monitoring is periodically received from the manager 3.

The steady monitoring management module 47, if not steadily monitored by the manager 3, sets ON the steady monitoring information flag 44. The TRAP management module 45, when the TRAP transmission occurs, refers to the steady monitoring information flag 44. If the flag 44 is set ON, the TRAP management module 45 requests the TCP stack module 6 to issue the command/response oriented command.

The agent 4 includes a TRAP weighting information table 42 in which to predefine a weight showing whether the connection-oriented command be issued before sending TRAP. The TRAP management module 45, when the TRAP transmission occurs, refers to the TRAP weighting information table 42 and thus judges whether the connection-oriented command is issued or not. If required, the TRAP management module 45 requests the TCP stack module 6 to issue the command/response oriented command.

The agent 4 includes a TCP transmission/receipt management module 49 for managing a transmission and receipt of the command/response oriented command. The TCP transmission/receipt management module 49, upon receiving a command transmission request from the TRAP management module 45, transmits the command to the TCP stack module 6, and notifies the TRAP management module 45 of whether a response is given or not. Further, if unable to confirm the receipt of the response due to timeout etc, the TCP transmission/receipt management module 49 requests the TCP stack module 6 to retry the issuance of the command.

The agent 4 includes the TRAP weighting information table in which to predefine a retry count for every TRAP in the case of issuing the command/response oriented command before sending TRAP. The TRAP management module 45, when requesting the TCP transmission/receipt management module 49 to transmit the command, obtains a retry count from the TRAP weighting information table 42, and transfers this retry count to the TCP transmission/receipt management module 49. If the retry process is executed in the TCP transmission/receipt management module 49, this process is done based on the retry count of which the TRAP management module 45 notifies.

Further, when the TRAP management requests the TCP transmission/receipt management module 49 to transmit the command, obtains a retry interval from the TRAP weighting information table 42 and notifies the TCP transmission/receipt management module 49 of this retry interval. If there try process is executed in the TCP transmission/receipt management module 49, this process can be also done based on the retry interval of which the TRAP management module 45 notifies.

### Examples of Multiple Operations of Agent-Resided System

### Operational Example 1

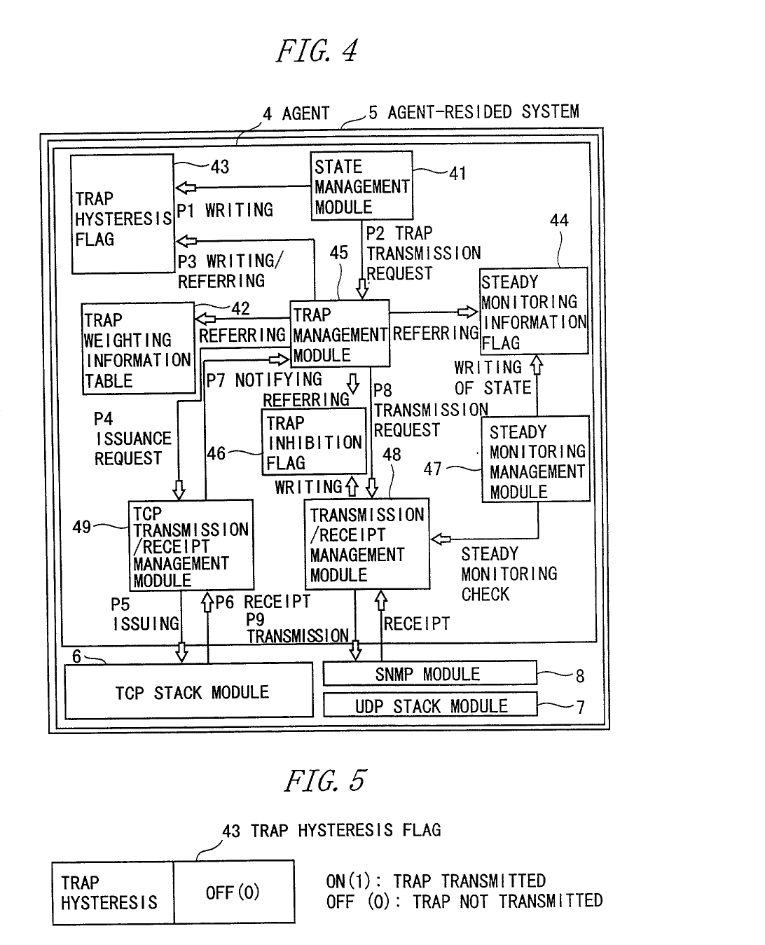

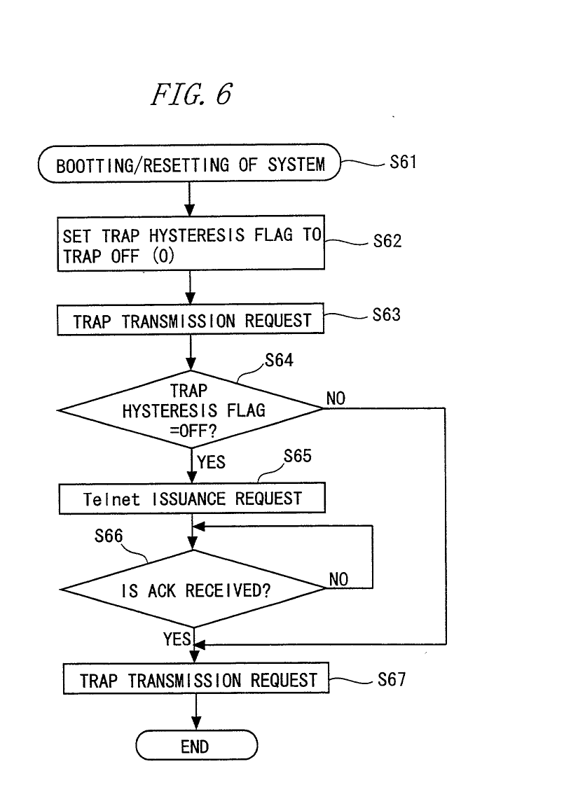

Next, an operational example 1 of the system 5 in which the agent 4 resides, will be described with reference to FIG. 4. FIG. 5 shows an example of a TRAP hysteresis flag 43. FIG. 6 shows a processing flowchart.

In the system 5 in which the agent 4 resides, upon power-on or resetting in this system, the agent 4 is booted, and then the state management module 41 sets a value of the TRAP hysteresis flag 43 in an OFF-state (OFF: 0) (operation procedure P1: processing steps S61, S62 in FIG. 6). Thereafter, the state management module 41 requests the TRAP management module 45 to transmit TRAP in order to notify the manager 3 of a change of state such as booting the system and so on (P2, S63).

The TRAP management module 45 receiving the TRAP transmission request refers to the value in the TRAP hysteresis flag 43 (P3) and recognizes that the flag value is 0 (OFF: TRAP transmission not set) (S64). As a result, the TRAP management module 45 judges that the command/response oriented command needs to be issued, and requests the TCP transmission/receipt management module 49 to transmit a Telnet command as a TCP command (P4, S65).

The TCP transmission/receipt management module 49 sends the Telnet command addressed to the manager 3 to the TCP stack module 6 (P5), and receives an ACK response (P6). Upon receiving this response, the TCP transmission/receipt management module 49 notifies the TRAP management module 45 of the ACK response (P7, S66).

The TRAP management module 45, when receiving the notification from the TCP transmission/receipt management module 49 (P7), requests the transmission/receipt management module 48 to transmit TRAP (P8, S67). The transmission/receipt management module 48 transmits TRAP as an autonomous message to SNMP module 8 (P9). The TRAP management module 45, after sending TRAP to the transmission/receipt management module 48, sets the value in the TRAP hysteresis flag 43 to 1 (ON: TRAP transmission set) (P3).

### Operational Example 2

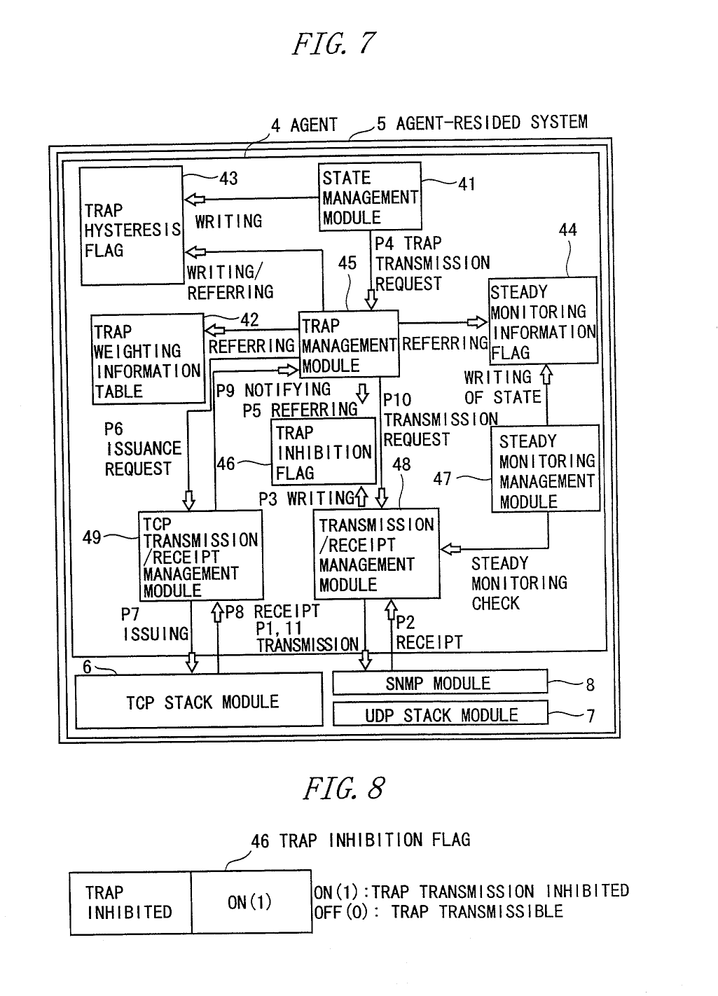

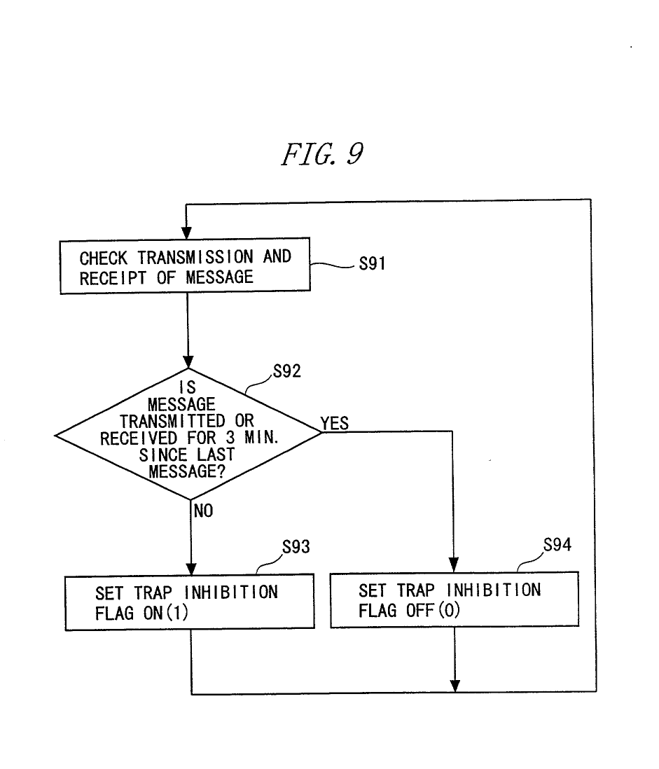

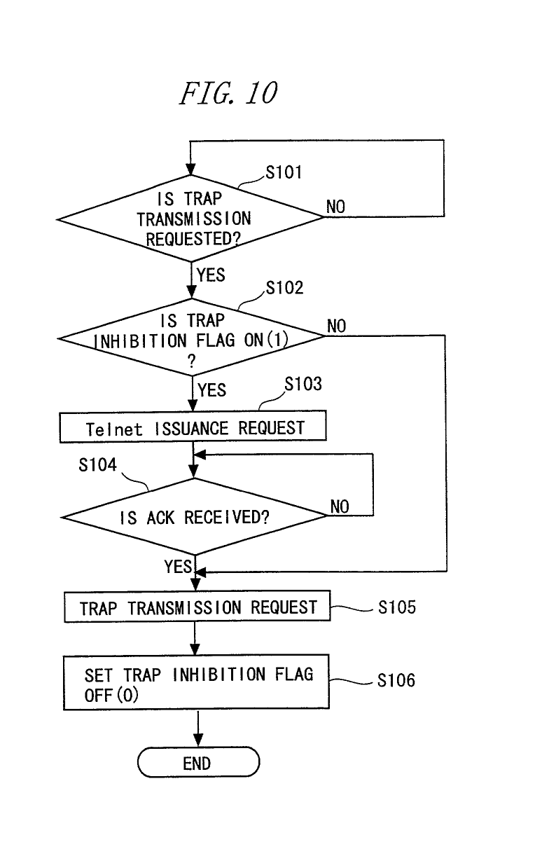

Next, an operational example 2 of the system 5 in which the agent 4 resides, will be described with reference to FIG. 7. FIG. 8 shows an example of the TRAP inhibition flag 46. Further, FIG. 9 is a flowchart showing processes of the transmission/receipt management module 48. FIG. 10 is a flowchart of processes of the TRAP management module 45, the transmission/receipt management module 48 and the TCP transmission/receipt management module 49.

In the system 5 in which the agent 4 resides, the transmission/receipt management module 48 performs a message management about whether the message is transmitted to or received from the manager 3 (processing step S91 in FIG. 9). The transmission/receipt management module 48, if any message is neither transmitted nor received for, e.g., 3 min since the final transmission or receipt (P1, P2, S92), sets the value in the TRAP inhibition flag 46 to 1 (ON: TRAP transmission inhibited) (S93).

When a change of state such as a trouble etc occurs, the state management module 41 requests the TRAP management module 45 to send TRAP in order to notify the manager 3 of the change of state (P4). Note that the transmission/receipt management module 48, when judging that the message is transmitted or received for 3 min since the final transmission or receipt (P1, P2, S92), sets the value in the TRAP inhibition flag 46 to 0 (OFF: TRAP transmissible) (S93).

The TRAP management module 45 refers to the TRAP inhibition flag 46 (P5) and recognizes that the flag 46 is set ON (1) (processing steps S101, S102 in FIG. 10). As a result, the TRAP management module 45 judges that the command/response oriented command needs to be issued, and requests the TCP transmission/receipt management module 49 to transmit a Telnet command (P6, S103). The TCP transmission/receipt management module 49 sends the Telnet command addressed to the manager 3 to the TCP stack module 6 (P7), and receives an ACK response (P8, S104)

Upon receiving this response, the TCP transmission/receipt management module 49 notifies the TRAP management module 45 of the ACK response (P9). The TRAP management module 45, when receiving this notification, requests the transmission/receipt management module 48 to transmit TRAP (P10, S105). The transmission/receipt management module 48 transmits TRAP as an autonomous message to SNMP module 8 (P11). The transmission/receipt management module 48 thereafter sets the value in the TRAP inhibition flag 46 to 0 (OFF: TRAP transmissible) (S106).

### Operational Example 3

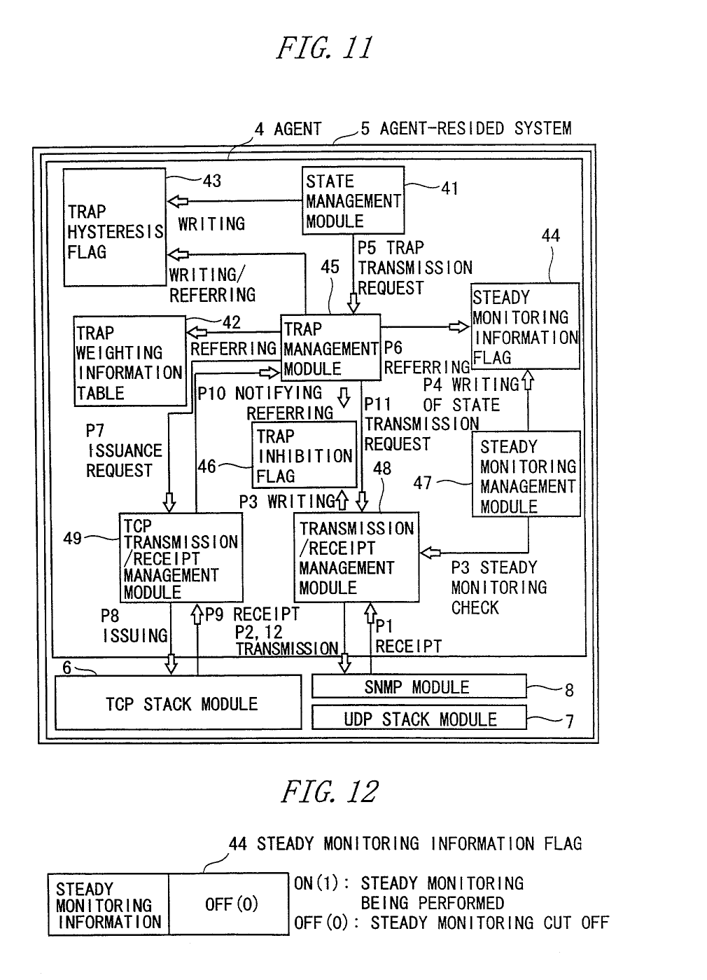

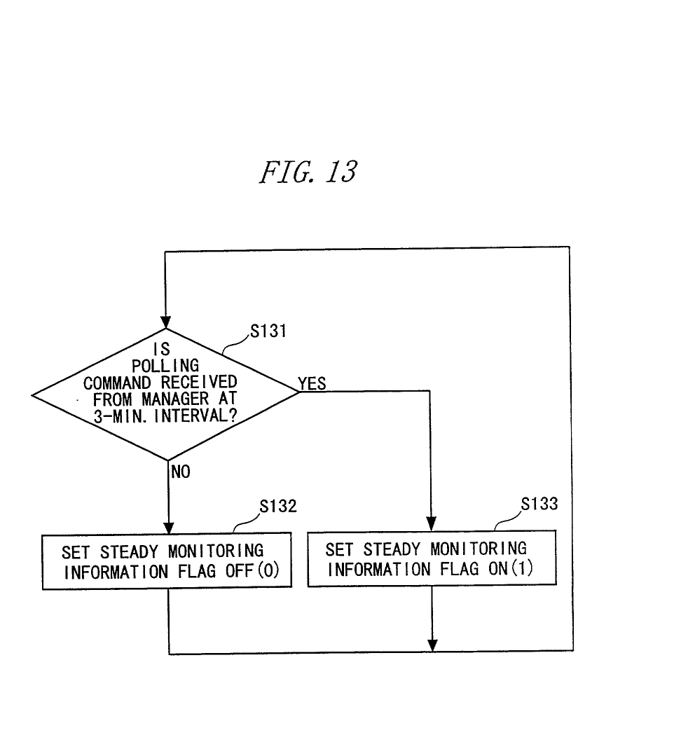

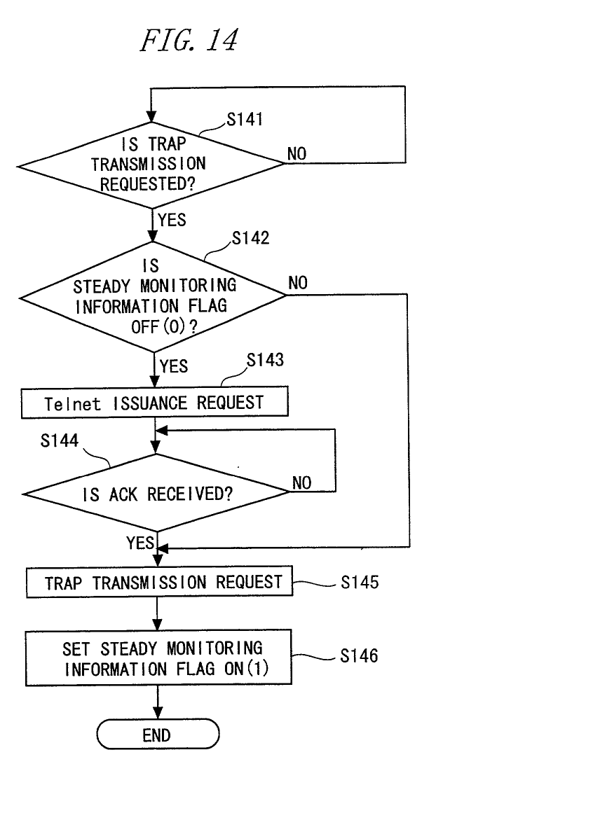

Next, an operational example 3 of the system 5 in which the agent 4 resides, will be described with reference to FIG. 11. FIG. 12 shows an example of the steady monitoring information flag 44. Further, FIG. 13 is a flowchart showing processes of the steady monitoring management module 47. FIG. 14 is a flowchart of processes of the TRAP management module 45, the steady monitoring management module 47 and the TCP transmission/receipt management module 49.

In the system 5 in which the agent 4 resides, the agent 4 receives a polling command periodically (e.g., at a 3-min interval) from the manager 3, and transmits a response thereto (P1, P2). The steady monitoring management module 47 checks whether the transmission/receipt management 48 receives the polling command at the 3-min interval from the manager 3 (P3, processing step S131 in FIG. 13).

If the manager 3 stops polling, the steady monitoring management module 47 recognizes that the polling command is not received, and sets a value in the steady monitoring information flag 44 indicating whether the steady monitoring is received, to 0 (OFF: steady monitoring cut off (P4, S132). Note that the steady monitoring management module 47, when recognizing in S131 that the polling command is received from the manager 3, sets the value in the steady monitoring information flag 44 to 1 (ON: steady monitoring being performed (P4, S133).

When a change of state such as a trouble etc occurs, the state management module 41 requests the TRAP management module 45 to send TRAP in order to notify the manager 3 of the change of state (P5, processing step S141 in FIG. 14). The TRAP management module 45, before making the TRAP transmission request, refers to the value in the steady monitoring information flag 44 (P6) and recognizes that the this flag 46 is set OFF (0S142) As a result, the TRAP management module 45 judges that the command/response oriented command needs issuing, and requests the TCP transmission/receipt management module 49 to transmit a Telnet command (P7, S143).

The TCP transmission/receipt management module 49 sends the Telnet command addressed to the manager 3 to the TCP stack module 6 (P8), and receives an ACK response (P9, S144). Upon receiving this response, the TCP transmission/receipt management module 49 notifies the TRAP management module 45 of the ACK response (P10). The TRAP management module 45, when receiving this notification, requests the transmission/receipt management module 48 to transmit TRAP (P1, S145).

The transmission/receipt management module 48 transmits TRAP as an autonomous message to SNMP module 8 (P12). Thereafter, when receiving the polling command from the manager 3, the steady monitoring management module 47 sets the value in the steady monitoring information flag 44 to 1 (ON: steady monitoring being performed) (S146)

### Operational Example 4

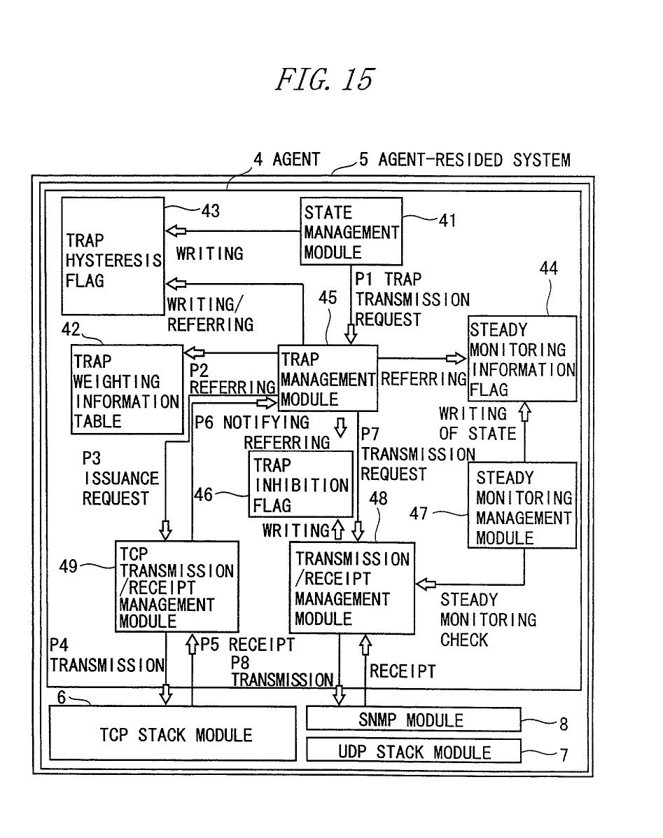

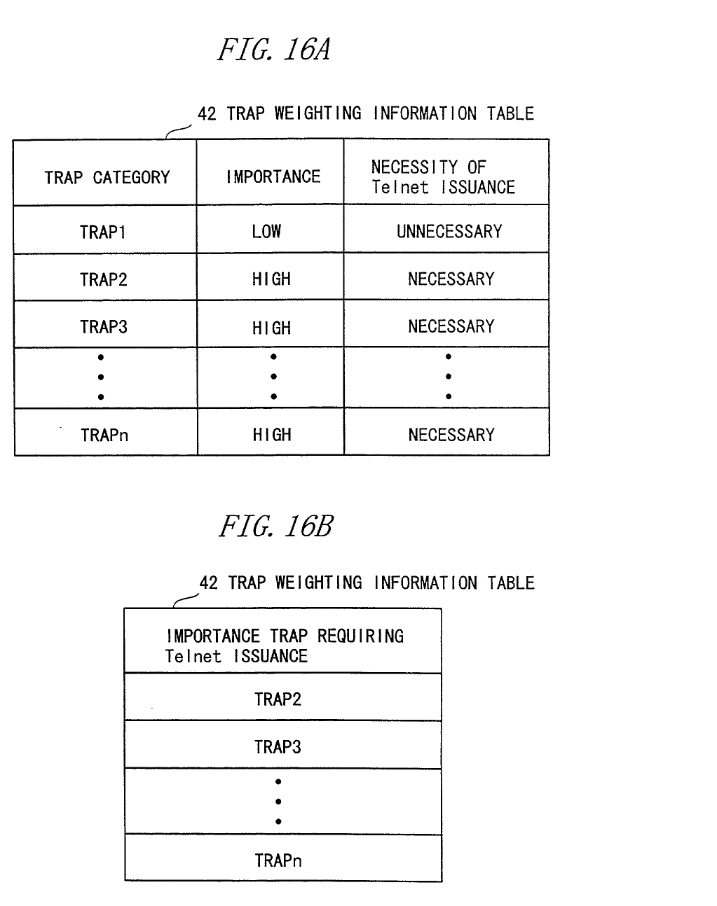

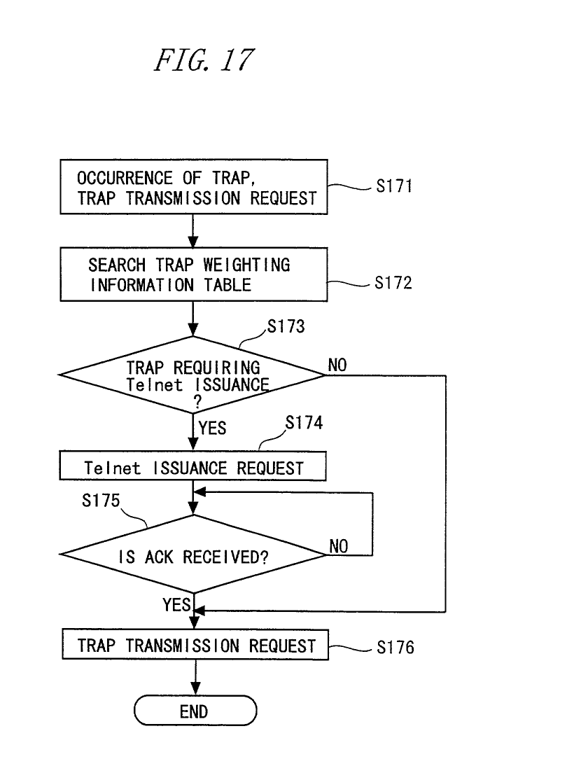

Next, an operational example 4 of the system 5 in which the agent 4 resides, will be described with reference to FIG. 15. FIG. 16 shows an example of the predefined TRAP weighting information table 42. FIG. 17 is a flowchart showing processes.

In the system 5 in which the agent 4 resides, when the state management module 41 requests the RAP management module 45 to send TRAP3 (P1, processing step S171 in FIG. 17), the TRAP management module 45 refers to the predefined TRAP weighting information table 42 (P2, S172), and recognizes that TRAP3 requires issuing a Telnet command (S173). As a result, the TRAP management module 45 requests the TCP transmission/receipt management module 49 to transmit the Telnet command (P3, S174)

The TCP transmission/receipt management module 49 sends the Telnet command addressed to the manager 3 to the TCP stack module 6 (P4), and receives an ACK response (P5, S175). Upon receiving this response, the TCP transmission/receipt management module 49 notifies the TRAP management module 45 of the ACK response (P6). The TRAP management module 45, when receiving this notification, requests the transmission/receipt management module 48 to transmit TRAP3 (P7, S176). The transmission/receipt management module 48 transmits TRAP1 as an autonomous message to SNMP module 8 (P8).

Further, when the state management module 41 requests the RAP management module 45 to send TRAP1 (P1, processing step S171), the TRAP management module 45 refers to the predefined TRAP weighting information table 42 (P2, S172), and recognizes that TRAP1 does not require issuing the Telnet command (S173). As a result, the TRAP management module 45 requests the transmission/receipt management module 48 to transmit TRAP1 (P7, S176), and the transmission/receipt management module 48 sends TRAP1 to the SNMP module 8 (P8) Note that it is possible to properly select a mode that all of TRAPs are defined as shown in FIG. 16(A), or a mode that necessary TRAPs are defined as shown in FIG. 16 (B) in the TRAP weighting information table 42.

### Operational Example 5

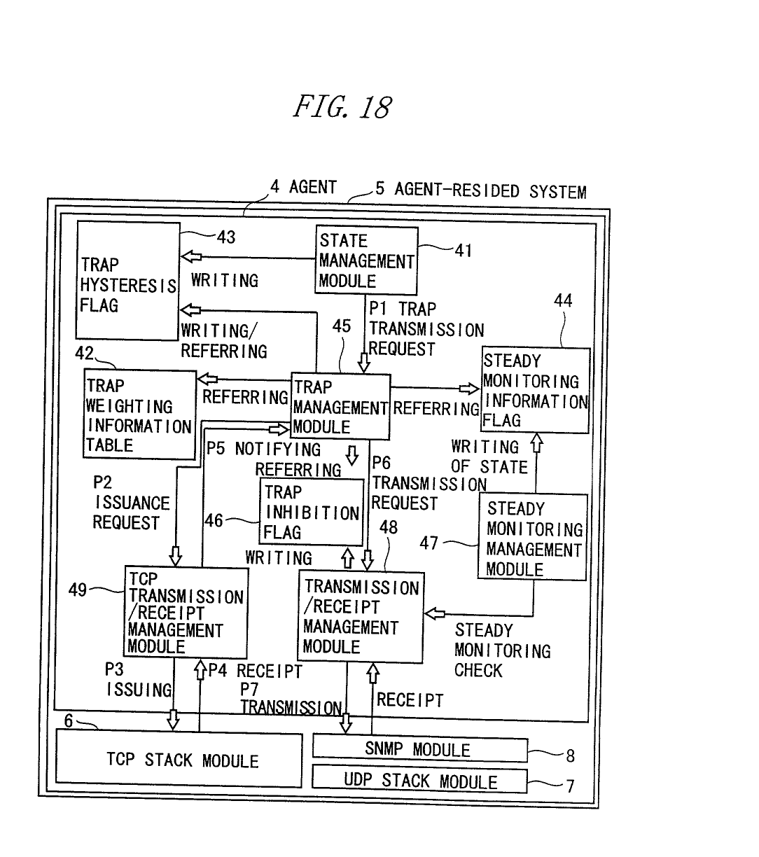

Next, an operational example 5 of the system in which the agent 4 resides will be described referring to FIG. 18.

In the system in which the agent 4 resides, a TRAP transmission request is given from the state management module 41 (P1), and the Telnet command is issued due to the factor in any one of the operational Examples 1 through 3 (P2). The TCP transmission/receipt management module 49 issues the Telnet command addressed to the manager 3 to the TCP stack module 6, and comes to a wait-for-ACK status. When receiving a timeout notification of the ACK response (P4), the TCP transmission/receipt management module 49 reissues the Telnet command (P3), and comes to the wait-for-ACK status.

Thus, the TCP transmission/receipt management module 49 retries to issue the Telnet command till it receives the ACK response (P4). When receiving the TCK response as a result of retrying (P4), the TCP transmission/receipt management module 49 notifies the TRAP management module 45 of the ACK response (P5). The TPAP management module 45 receiving this notification requests the transmission/receipt management module 48 to transmit TRAP (P6), and the transmission/receipt management module 48 transmits TRAP as an autonomous message to the SNMP module 8 (P8).

### Operational Example 6

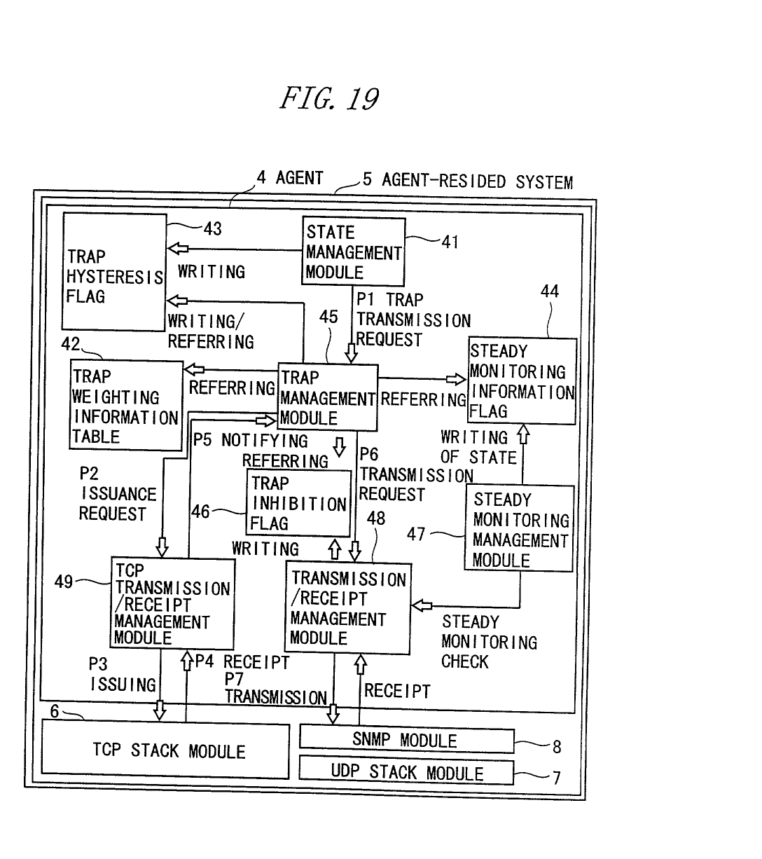

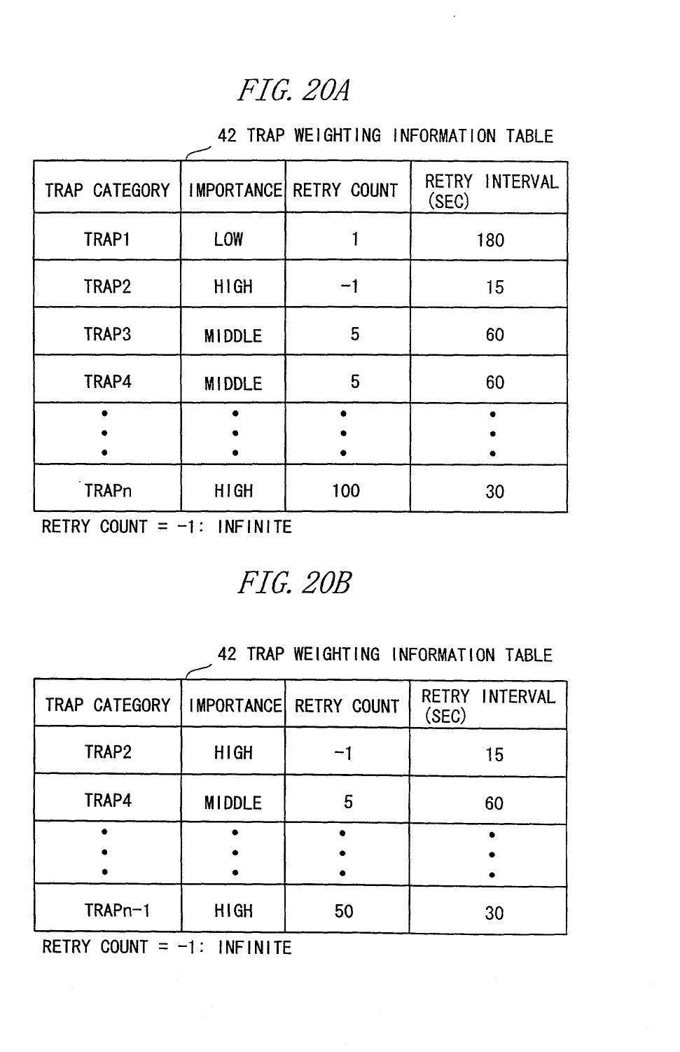

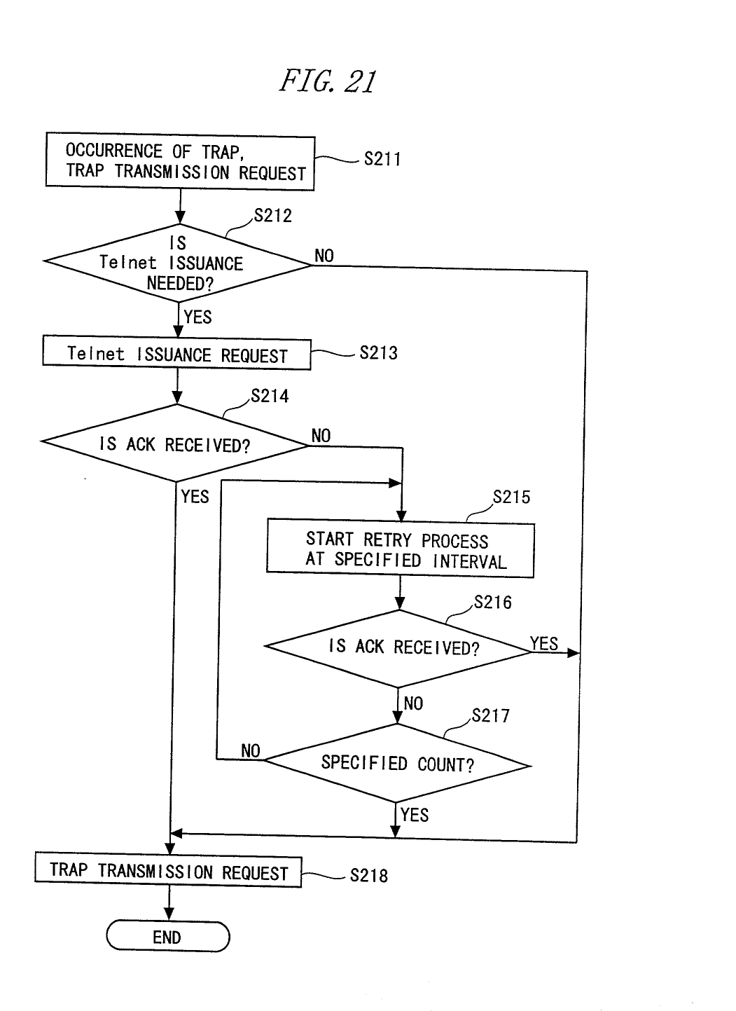

Next, an operational example 6 of the system 5 in which the agent 4 resides, will be described with reference to FIG. 19. FIG. 20 shows an example of the predefined TPAP weighting information table 42. Further, FIG. 21 is a flowchart showing processes.

In the system 5 in which the agent 4 resides, the TRAP transmission request is given from the state management module 41 (P1, processing step S211 in FIG. 21), and the Telnet command is issued due to the factor in any one of the operational examples 1 through 3 (P2, S212). A TRAP category as a command name, a retry count and (or) a retry interval as parameters are set in the TRAP weighting information table 42. The TCP transmission/receipt management module 49 issues the Telnet command to the TCP stack module 6 (P3, S213) and comes to the wait-for-ACK status.

If unable to receive ACK due to the timeout etc (S214) the retry process starts being executed with the retry count or at the retry interval as specified by the parameter transferred in P2. If receiving ACK during the retry process, the retry process is interrupted, and the TRAP management module 45 is notified of the ACK response (P5, S215, S216, S217). If unable to receive the ACK response during the retry process, the TRAP management module 45 is notified of no ACK response (P5, S215, S216, S217).

The TRAP management module 45, upon receiving some notification in P5, requests the transmission/receipt management module 48 to transmit TRAP (P6, S218), and the transmission/receipt management module 48 transmits TRAP to the SNMP module 8 (P7). Note that it is possible to properly select the mode that all of TRAPs are defined as shown in FIG. 20(A) or the mode that necessary TRAPs are defined as shown in FIG. 20(B) in the TRAP weighting information table 42.

As discussed above, according to the present invention, the agent is capable of surely delivering the autonomous message (TRAP based on SNMP) to the manager on the basis of the connectionless protocol (UDP), whereby a miss and a delay in troubleshooting a critical trouble or detecting an important event due to a loss of the autonomous message can be minimized.

Further, the present invention involves the use of the standard-implemented command (protocol) as the command/response oriented (connection-oriented protocol: TCP) command and can be applied to the multi-vendor environment.

Although only a few embodiments of the present invention have been described in detail above, those skilled in the art will readily appreciate that many modifications are possible in the preferred embodiments without departing from the novel teachings and advantages of this invention. Accordingly, all such modifications are intended to be included within the scope of the present invention as defined by the following claims.

What is claimed is:

1. An autonomous message transmission method in a manager-to-agent model system including a manager and an agent respectively accommodated in an IP network, said method comprising:
transmitting a command/response oriented command based on a connection-oriented protocol to said manager from said agent before transmitting a first autonomous message including a time when starting up a system; and
transmitting an autonomous message based on a connectionless protocol when confirming some response to said agent from said manager.

2. An autonomous message transmission method in a manager-to-agent model system including a manager and an agent respectively accommodated in an IP network, said method comprising:
managing communications with said manager when normally operated after starting up a system;
transmitting a command/response oriented command based on a connection-oriented protocol before said agent transmits an autonomous message based on a connectionless protocol to said manage if a predetermined time elapses since a message was finally received from said manager or transmitted to said manager; and
transmitting the autonomous message when confirming some response to said agent from said manager.

3. An autonomous message transmission method in a manager-to-agent model system including a manager and an agent respectively accommodated in an IP network, said method comprising:
monitoring a signal receiving interval in periodic monitoring in said agent when said manager periodically monitors said agent;
transmitting a command/response oriented command based on a connection-oriented protocol before transmitting an autonomous message based on a connectionless protocol when judging that the signal for the periodic monitoring is not received; and
transmitting the autonomous message when confirming some response to said agent from said manager.

4. An autonomous message transmission method in a manager-to-agent model system including a manager and an agent respectively accommodated in an IP network, said method comprising:
transmitting an autonomous message based on a connectionless protocol to said manager from said agent; and
judging whether to transmit a command/response oriented command based on a connection-oriented protocol in accordance with a weight of the predefined autonomous massage before transmitting the autonomous message based on the connectionless protocol.

5. An autonomous message transmission method according to claim 1, 2 or 3, wherein the transmission of the command/response oriented command is retried till the response from said manager to said agent is confirmed, and
the autonomous message is transmitted when confirming the response.

6. An autonomous message transmission method according to claim 5, wherein retry count information mapped to the weight of the autonomous message is retained, and
a retry count of the transmission of the command/response oriented command is set changeable based on the weight of the autonomous message.

7. An autonomous message transmission method according to claim 5, wherein retry interval information mapped to the weight of the autonomous message is retained, and
a retry interval of the transmission of the command/response oriented command is set changeable based on the weight of the autonomous message.

8. An autonomous message transmission method according to claim 1, wherein the connectionless protocol is SNMP that supports UDP, and
the autonomous message is TRAP based on SNMP.

9. An autonomous message transmission method according to claim 1, wherein the connection-oriented protocol is Telnet that supports TCP.

10. An agent-resided system comprising:
a module transmitting a command/response oriented command based on a connection-oriented protocol to a manager via an IP network before transmitting a first autonomous message including a time when starting up said system; and
a module transmitting an autonomous message based on a connectionless protocol when confirming some response from said manager.

11. An agent-resided system comprising:
a module managing communications with a manager via an IP network when normally operated after starting up said system;
a module transmitting a command/response oriented command based on a connection-oriented protocol before transmitting an autonomous message based on a connectionless protocol to said manage if a predetermined time elapses since a message was finally received from said manager or transmitted to said manager; and
a module transmitting the autonomous message when confirming some response from said manager.

12. An agent-resided system comprising:
a module monitoring a signal receiving interval in periodic monitoring in said agent when a manager executes periodic monitoring via an IP network;
a module transmitting a command/response oriented command based on a connection-oriented protocol before transmitting an autonomous message based on a connectionless protocol when judging that the signal for the periodic monitoring is not received; and
a module transmitting the autonomous message when confirming some response from said manager.

13. An agent-resided system comprising:
a module transmitting an autonomous message based on a connectionless protocol to a manager via an IP network; and
a module judging whether to transmit a command/response oriented command based on a connection-oriented protocol in accordance with a weight of the predefined autonomous massage before transmitting the autonomous message based on the connectionless protocol.

14. An agent-resided system according to claim 10, 11 or 12, wherein the transmission of the command/response oriented command is retried till the response from said manager to said agent is confirmed, and
the autonomous message is transmitted when confirming the response.

15. An agent-resided system according to claim 14, further comprising a module retaining retry count information mapped to the weight of the autonomous message, and setting changeable a retry count of the transmission of the command/response oriented command on the basis of the weight of the autonomous message.

16. An agent-resided system according to claim 14, further comprising a module retaining retry interval information mapped to the weight of the autonomous message, and setting changeable a retry interval of the transmission of the command/response oriented command on the basis of the weight of the autonomous message.

17. An agent-resided system according to claim 10, wherein the connectionless protocol is SNMP that supports UDP, and
the autonomous message is TRAP based on SNMP.

18. An agent-resided system according to claim 10, wherein the connection-oriented protocol is Telnet that supports TCP.
